(19) United States
(12) Patent Application Publication
(10) Pub. No.: US 2013/0033586 A1
(43) Pub. Date: Feb. 7, 2013

(54) System, Method and Apparatus for Generation, Transmission and Display of 3D Content

(71) Applicant: Samir Hulyalkar, Los Gatos, CA (US)

(72) Inventor: Samir Hulyalkar, Los Gatos, CA (US)

(21) Appl. No.: 13/641,868

(22) PCT Filed: Apr. 19, 2011
(86) PCT No.: PCT/US2011/032964

§ 371 Date: Oct. 17, 2012

Related U.S. Application Data
(60) Provisional application No. 61/326,397, filed on Apr. 21, 2010.
(60) Provisional application No. 61/333,332, filed on May 11, 2010.

(51) Int. Cl. H04N 13/02

(52) U.S. Cl. 348/51; 348/E13.026

(57) ABSTRACT

A method of and system and apparatus for, generating visual information from left and right (L/R) view information and depth information, comprising computing left and right projections of L/R view information in three-dimensional space, combining the occluded portions of the computed projections in three-dimensional space, and mapping the combined projections to two-dimensional space according to a desired projection point.

### CROSS REFERENCE TO RELATED APPLICATIONS

This application claims the benefit of U.S. Provisional Patent Application No. 61/326,397, filed 21 Apr. 2010, and entitled System, Method and Apparatus for Generation, Transmission and Display of 3D Content, the entire disclosure of which is incorporated herein by reference.

This application also claims the benefit of U.S. Provisional Patent Application No. 61/333,332, filed 11 May 2010, and entitled System, Method and Apparatus for Generation, Transmission and Display of 3D Content, the entire disclosure of which is incorporated herein by reference.

### BACKGROUND

The present invention is in the technical field of 3D content. More particularly, the present invention is in the technical field of generation, distribution and display of content visually perceivable by humans; for example, video, graphics and images in 3 dimensions.

3D displays are of two kinds: those that require the use of glasses (called stereoscopic) and those that do not require the use of glasses (called auto-stereoscopic).

There are some issues with stereoscopic displays. The 3D stereoscopic experience can cause health issues, such as headaches. Prolonged 3DTV viewing has been shown to result in vomiting, dizziness and epilepsy according to studies in Japan. This effect is primarily due to the brain receiving conflicting cues while watching 3D, due to: a) crosstalk between L and R images, and, b) conflict between “accommodation” and “vergence”. Accommodation is the process by which the human eye changes to focus on an object as its distance changes. Vergence is the simultaneous movement of both eyes in opposite directions to obtain or maintain single binocular vision. Accommodation is the focusing of the eyes and vergence is the rotation of the eyes. For a 3D display at a certain position, the human eyes need to be focused on one specific distance. However, the left and the right eyes are given vergence cues to rotate to get the 3D effect. This results in a conflict as described in “Human factors of 3-D displays, Robert Patterson, Journal of the SID 15/11, 2007”.

The 3D experience today results in significantly reduced illumination ranging from 15-20% of the illumination of a 2D experience for all displays such as LCD TV, Plasma TV, or 3D Cinema. Light is an extremely valuable resource as manufacturers drive toward better power efficiency, higher contrast, and reduced susceptibility to ambient lighting.

These problems can be considerably ameliorated if glasses can be eliminated. Autostereoscopic displays are of generally two basic types. The first type is those that modify existing displays via adding an external lens or film, or modify some small portion of the existing display, such as lenticular-lens-based displays sold by Philips and Alisotrophy, as described in U.S. Pat. No. 6,064,424, parallax-barrier-based as described in U.S. Pat. Nos. 4,853,769 and 5,315,377, or prism-film based as described in 3M patent application US2009/0316058 A1. The main idea behind autostereoscopic displays is to be able to project two different views to the left and right eyes, for example, by using vertical lenses in a lenticular-lens-based display. To increase the display viewing angle, multiple “views” are created for the different angles, as described in “Multiview 3D-LCD” by C. van Berkel et al in SPIE Proceedings, Vol. 2653, 1996, pages 32-39. This results in a loss of resolution by a factor proportional to the number of views. These solutions have the following problems: a) more expensive than the stereoscopic displays as they require an external film affixed to the display; b) cartoonish due to loss of resolution for multiple views; c) image appears 3D only when the eyes are aligned well with the left and right viewing cones—this within the zone of 3D viewability called 3D coverage in the following. If the eyes are misaligned, between the zones, or if one gets too close or too far away from the display, or if the viewer tilts her head, then the 3D effect is not only gone, but the image appears blurry and is not viewable, i.e., the picture does not degrade “gracefully” into a 2D-only experience; d) there is still a problem between “accommodation” and “vergence”; and e) there is still a loss in illumination due to the use of filters/films/etc.

These problems can be reduced via multiple solutions, such as eye tracking system with dynamically changing left and right view cones, for example, as described in US 2008/0143895 A1 and/or using increased resolution or frame-rate to accommodate multiple views. Still there are some issues. Cost is increased due to the sophisticated analysis required to determine the eye positions of possibly multiple viewers. While covering some of the gaps in 3D coverage, it still may not solve all the gaps such as coming too close to the display or too far from the display or a tilted head position. Note that there is still not a graceful degradation of the 3D experience to the 2D experience. There is still a problem between “accommodation” and “vergence”. There is still a loss in illumination due to the use of filters/films/etc. Due to the above issues, autostereoscopic displays based on modification of the current 2D displays are currently being used in limited applications, for example, in the Digital Signage market.

The second class of autostereoscopic displays may use completely different technologies, such as holographic displays as described in US 2006/0187297 A1. These displays are currently too expensive and will require a long period of sustained innovation for them to be of ubiquitous use.

Finally a recent approach, as described in U.S. Pat. No. 7,043,074 B1, attempts to realize 3D using a conventional 2D display, i.e., without using any of the stereoscopic and autostereoscopic concepts. Assuming a 2D display, a blurred version of the right frame is added to the left frame, or vice versa, and the same frame is viewed by both eyes. This appears to make the image sharper and some 3D effect is realized, but it is not as much as perceived when viewing stereoscopic or autostereoscopic displays.

It is known that it is a property of the human visual system that stereopsis cues, defined as visual cues such as accommodation, vergence, and binocular disparity, are mainly applicable to viewing nearby objects, generally within several meters in front of us, as described in “Human factors of 3-D displays, Robert Patterson, Journal of the SID 15/11, 2007”.

For all the effort in presenting binocular vision via stereoscopic and autostereoscopic displays, industry has still not provided cost effective displays with a strong, bright and natural 3D effect.

### SUMMARY

The inventor realized, as unappreciated heretofore, that humans do not perceive separate left and right images, but instead the human brain creates a 3D effect via a sophisticated combination of left and right images. The main idea is that we can mimic this processing in a conventional display, thereby providing a 3D effect to the brain.

Therefore the inventor appreciated that the above problems can be solved by a method of, and system and apparatus for, generating visual information from left and right (L/R) view information and depth information, comprising computing left and right projections of L/R view information in three-dimensional space, combining the occluded portions of the computed projections in three-dimensional space, and mapping the combined projections to two-dimensional space according to a desired projection point.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings, wherein like numerals indicate like elements:

FIG. 1 shows a block diagram of the prior art for the generation, transmission and display of 3D content;

FIG. 2a shows the processing in the human brain in response to cues of binocular vision, accommodation, vergence and others;

FIG. 2b shows the desired processing to emulate the processing of the brain via a display device thereby creating See-3D video;

FIG. 2c shows an embodiment of the method of generation, transmission and display of 3D content;

FIGS. 3a, 3b and 3c show the methods used by stereoscopic cameras of an object on the left and right views to simulate the object position at zero depth (or point of focus), background object, and a foreground object respectively;

FIG. 3d summarizes the methods illustrated in FIGS. 3a, 3b, and 3c;

FIG. 4a, 4b shows the left and the right view of the foreground object, respectively;

FIG. 4c shows the human brain processing of the foreground object;

FIG. 5a shows the left and right view and the depth map of a 3D object;

FIG. 5b shows the 3D projection map of the left view of the 3D object at the required point of projection, called the center position;

FIG. 5c shows the 3D projection map of the right view of the 3D object at the center position;

FIG. 5d shows the method of fusing left and right views for an object with positive depth, given a center position and the display plane;

FIG. 5e shows the method of fusing left and right views for an object with negative depth, given a center position and the display plane;

FIG. 5f shows the method of fusing left and right views for an object with a non-overlapping background, while focused on the foreground object, for an object with positive depth, given a center position and the display plane;

FIG. 5g shows the method of fusing left and right views for an object with a non-overlapping background, while focused on the background object, for an object with positive depth, given a center position and the display plane;

FIG. 5h shows the method of fusing left and right views for an object with an overlapping background, while focused on the foreground object, for an object with positive depth, given a center position and the display plane;

FIG. 5i shows the method of fusing left and right views for an object with an overlapping background, while focused on the background object, for an object with positive depth, given a center position and the display plane;

FIG. 6a shows the block diagram for generation of See-3D video;

FIG. 6b shows a simplified approach for generation of See-3D video;

FIG. 7 shows the a method for improving an autostereoscopic or stereoscopic 2D/3D display using See-3D video;

FIG. 8a, 8b, 8c show different realizations of an encoding method for sending 3D information;

FIG. 8d shows an embodiment of an encoding method for sending 3D information;

FIG. 9 shows the processing at a 3D receiver for modifying 3D content according to the end user requirements, for example, change 3D depth, enhance 3D viewing, add 3D graphics.

FIG. 10a shows the processing at a 3D transmitter for modifying 3D content to create a L/R-3D view and the associated object based information.

FIG. 10b shows the processing at a 3D receiver for performing 3D occlusion combination and modifying 3D content according to the end user requirements, for example, change 3D depth, enhance 3D viewing.

### DETAILED DESCRIPTION

In one aspect, a 3D effect may be created by displaying See-3D video, defined as the processing used to simulate the brain processing of fusion of video obtained via left and right eyes, based on the information provided via a left and/or right View and/or Depth information, on a conventional 2D display via one or more of the following techniques: use of perspective projection techniques to capture video according to the depth map for the scene, which can be obtained via the left/right views or via the capture of depth information at the source; enhancement of the foreground/background effect via proper handling of the differences perceived in the same object between the left and right views, and/or the use of blurring/sharpening to focus left/right view to a particular distance; this can be used for video or graphics; time-sequential blurring/sharpening done on the fused left/right view in accordance with how a human focuses at different depths computed according to the depth map for the scene; adding illumination effects to further enhance the 3D effect.

The See-3D video is created analogously to the image that is created in the brain using binocular vision and not the image that is sent to the two eyes separately. Among others, advantages include: reduced cost due to use of a conventional 2D display; no issues of accommodation versus vergence; no loss in illumination; consistent 3D view at all the points.

Another aspect is to ameliorate the issues with autostereoscopic or stereoscopic 3D displays by: generating See-3D video in accordance with the above and time-sequential output of See-3D video and L/R multi-view video on an autostereoscopic or stereoscopic display (which reverts to a 2D display mode while showing the 2D video). Since in this case, the effective frame rate is at least doubled, either a display with faster refresh rate or a scheme that alternates between the See-3D video and the L/R multi-view video can be used.

In this aspect, the 3D effect is obtained as a combination of the 2D video that is created in the brain and the stereopsis cues via the L/R display. The L/R video are used typically to enhance the perception of closer objects, and the See-3D video is used to enhance the resolution, improve illumination and the perception of more distant objects, while ensuring that consistent cues are provided between the L/R video and the See-3D video. Essentially the See-3D video is a “fallback” from the stereo view formed in the brain using binocular vision with L/R views. With this approach, the advantages include the capability of generating multiple views with improved resolution, better coverage and graceful degradation from a “true” 3D effect to a “simulated” 3D effect, the “simulated” 3D effect dominating the user experience when in a non-coverage zone, and improved illumination.

A third aspect is to improve the data available at the time of data creation by providing additional information during the creation of the stereo video or graphics content. This content may typically comprise L/R views either during the process of creation (for example, graphics content) or via processing using 2D to 3D conversion techniques or content generated using a 2D image+depth format. However, neither of these approaches provides complete information. This information can be improved in the following ways.

L/R view and depth map of the scene may be created. A L/R stereo camera may be added with a depth monitor at half the distance from the L and R capture module, or a graphics processor may compute the depth map. In the following, the depth map or depth information is defined as the depth information associated with the necessary visible and occluded areas of the 3D scene from the perspective of the final display plane and can be represented, for example, as a layered depth image as described in “Rendering Layered Depth Images”, by Steven Gortler, Li-wei He, Michael Cohen, Microsoft Research MSTR-TR-97-09, Mar. 19, 1997. Typically the depth map will be provided from a plane parallel to the final display plane, although it is possible to also provide depth maps associated with the Left, Right and Center views. The depth map also contains the focus information of the stereoscopic camera-point of focus and the depth of field, which is typically set to a particular value for at least one frame of video.

Multiple L/R views may be created of the same scene with different point of focus and different depth of field.

One of the following may be transmitted: (i) the L/R view(s) and the depth map, the additional depth information can be encoded separately; (ii) L/R view(s) and the See-3D video as an additional view computed as described above, the depth map can also be sent to enable optional 3D depth changes, 3D enhancement, and add locally generated 3D graphics; (iii) See-3D video and an optional depth map for 3D depth changes, 3D enhancement, and add locally generated graphics.

Standard compression techniques including MVC, H.264, MPEG, WMV, etc., can be used after the specific frames are created in accordance with any of the above (i)-(iii) approaches.

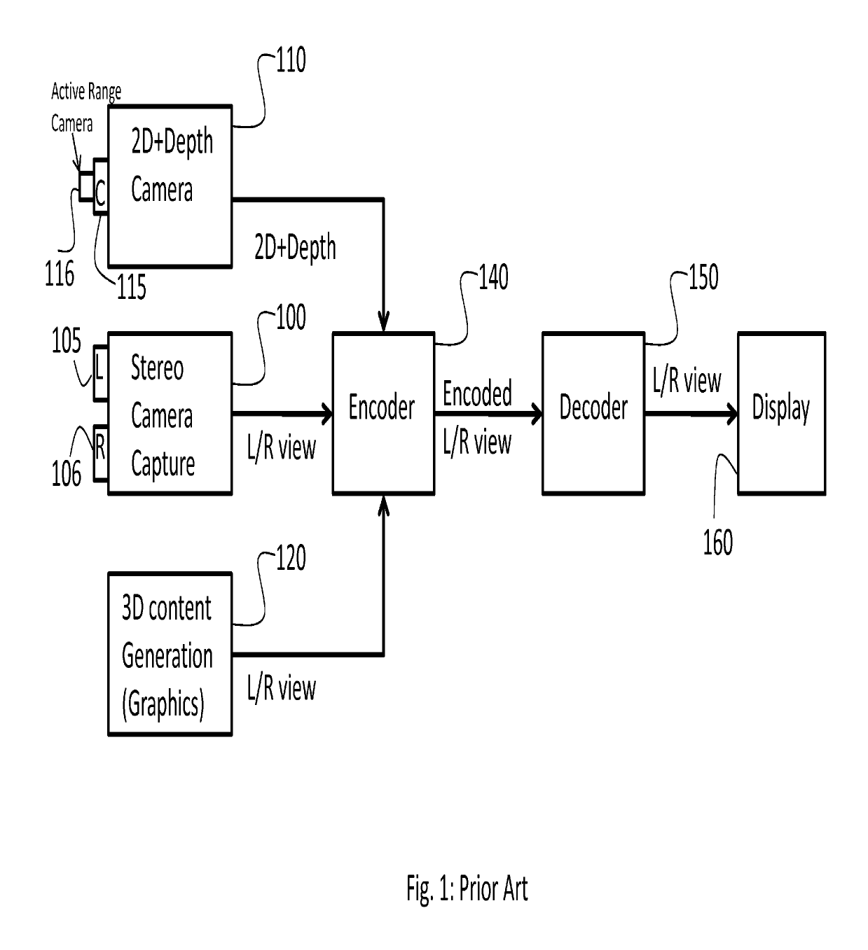

FIG. 1 shows a block diagram of a conventional method of generation, transmission and display of 3D content that may generally comprise: a stereo capture camera (or video camera) 100 with left and right view cameras 105 and 106 respectively—the output of the stereo camera module is left and right view information; a 2D+depth camera 110 with a center-view camera 115 with a 2D image output and an active-range camera 116 with a Depth map from the camera to the object; a graphics device 120, which could be any module that generates content such as a gaming machine, 3D menus, etc. Generally the graphics device includes a 3D world view for each one of its objects and typically generates a L/R view for true 3D content. Alternatively, the graphics device may generate 2D+Depth.

Encoder 140 performs conventional analog-to-digital encoding, for example, JPEG, H.264, MPEG, WMV, NTSC, HDMI, for the video content (L/R views or the 2D video). The depth map can also be encoded as a Luma component-only case using conventional analog-to-digital encoding formats. The encoded information is then sent over a transmission channel, which may be over air broadcast, cable, DVD/Blu-ray, Internet, HDMI cable, etc. Note there may be many transcoders in the transmission chain that first decode the stream and then re-encode the stream depending on the transmission characteristics. Finally the decoder 150 at the end of the transmission chain recreates the L/R or 2D video for display 160.

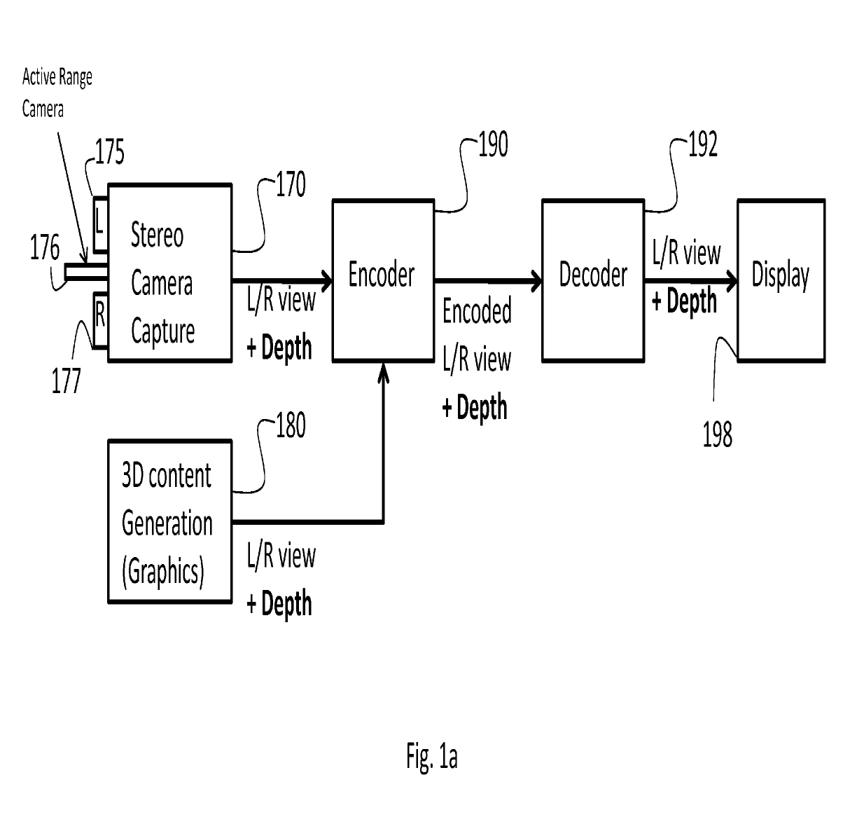

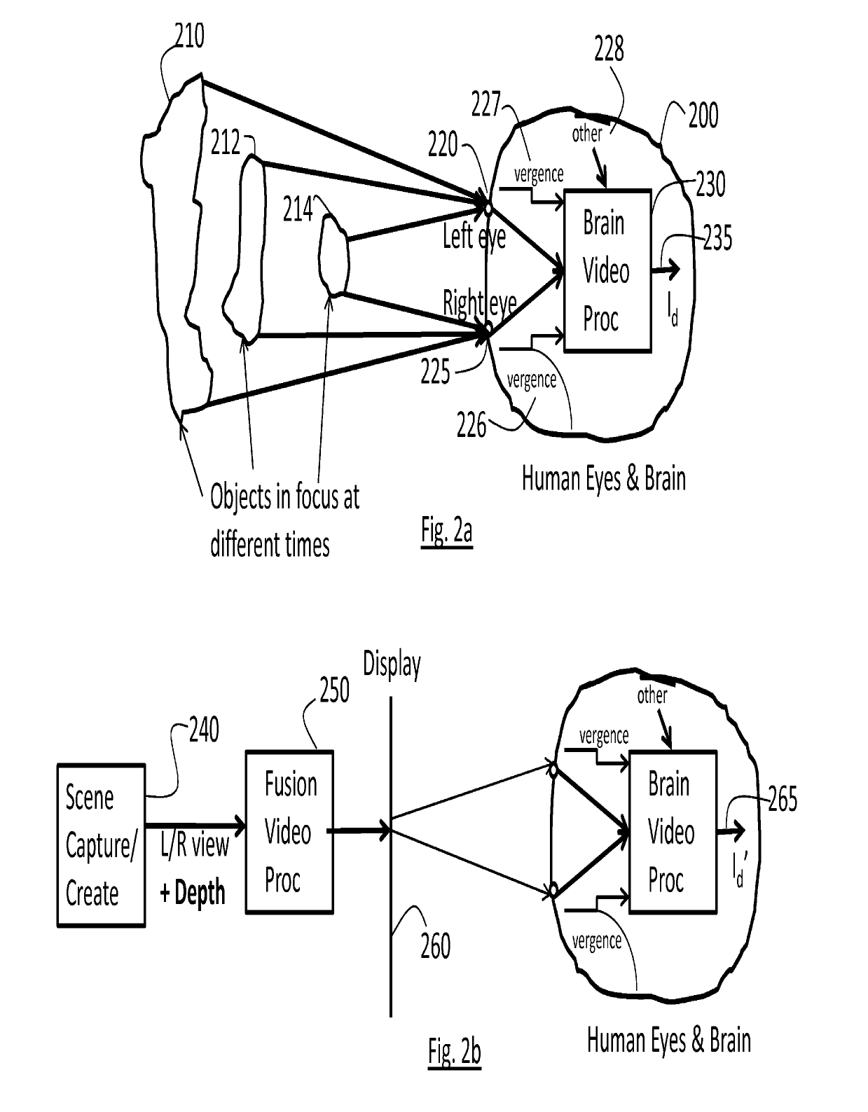

FIG. 2a shows the typical activity of the human eyes and brain 200 while processing objects 210, 212 and 214. The left eye 220 and the right eye 225 observe these objects and then present these views to the human brain. Note that an eye can only focus at a particular distance. Hence to properly perceive a 3D scene, the eyes must focus on the objects 210, 212 & 214, which are at different distances from the eyes, at different times; and the brain must be able to combine all of this information to create its consolidated view. Note that the brain creates only one view. It also uses other cues 226, 227, 228, such as the vergence and accommodation information 226, 227, to help in creating the fused image I_{d} 235, which is the output of the brain processing module.

In one aspect, the act of fusing binocular views in the brain via external video processing may be simulated. Block 240 outputs captured/created/generated scene information. Block 250 with output 255 (also shown as See-3D video) and display 260 function such that even though the left and right eyes see the same information, the output 265 I_{d}′ of the human brain processing is perceived 3D; i.e., 265 of FIG. 2b is made as similar to 235 of FIG. 2a as practical so that the viewer enjoys a “nearly natural” 3D experience.

Given that the display 260 is a conventional 2D display, the left and the right views are the same. Therefore, fusing the left and the right views is done by the video processing block 250. This must take into account important information that the brain needs to perform this fusion.

The left and the right eye views provide different perspectives of the same object. Typically every object in this view will have three components of the view: a common area between the two views, this may not always be there—especially for thin objects; an area of the object which is seen only in the left view, which will be called the right occluded view of the object; an area of the object which is seen only in the right view, which will be called the left occluded view of the object; depth information to be able to fuse the whole scene together; while the brain is focused on any specific depth, the other objects are out of focus in accordance with the distance to the focal point.

To properly capture 3D with high fidelity, then, it is important to have very good depth information of the scene. While it is possible to generate the depth view from the left and right views, it is much more accurate to generate depth information at the source. This high fidelity generation of 3D content may be accomplished by block 190 of FIG. 2c. A stereo camera with depth information 170 may generate the left/right views and depth information, which may be obtained by left camera 175, right camera 177 and the active range camera 176. Note that the depth information could comprise depth fields from left, right and also center point of view. As described above, the depth information also includes the camera's properties such as point of focus and the depth of field for the camera. It is also possible that multiple left and right cameras may be used to capture the scene at different focus points and depth-of-field. For a graphics scene, which is typically generated as projections from an internal 3D model, it would also be necessary to generate the depth information. This information should be easily available as it is used to generate the L/R views from the internal 3D model. Since a graphics object is always in focus, the different points-of-focus may be obtained by blurring according to a depth map. The encoder 190 encodes the L/R video and the depth map; the decoder 192 does the inverse of the encoder 190 and the display 198 shows this on the display.

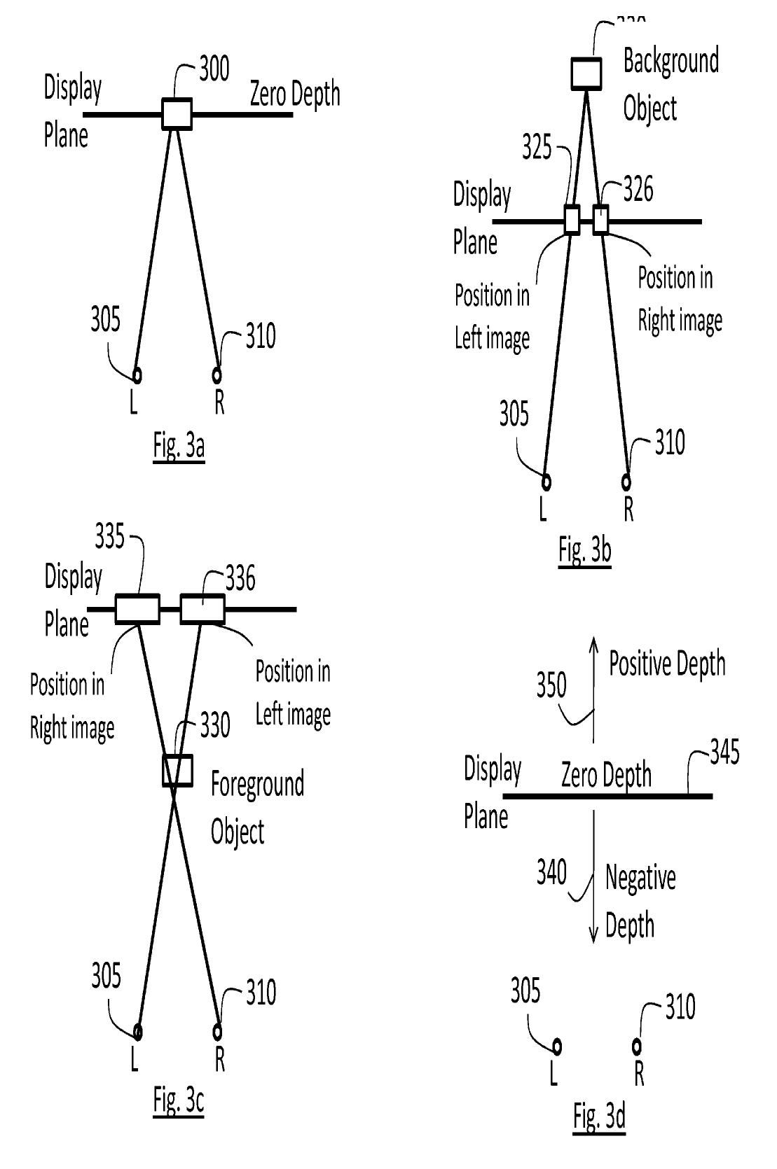

It is useful to understand how the left and right views are generated for display on a stereoscopic display. FIG. 3a shows the left and right views of object 300 required to be presented at zero depth or the display plane. In that case, left eye 305 and right eye 310 are shown the same image. As shown in FIG. 3b, if the object is behind the display plane, or is a background object 320, then the object is moved left on the display plane at position 325 for the left eye, and moved right on the display plane 326 for the right eye. As shown in FIG. 3c, if the object is to appear to be in front of the display plane, or is a foreground object 330, then the object is moved right at position 335 for the left eye, and moved left 336 for the right eye. FIG. 3d summarizes this as zero depth 345 for the object at focus, background objects as objects with positive depth 350, and foreground objects as objects with negative depth 340.

The following summarizes how the brain fuses the two left and right images together. Consider a scene with a foreground object and the background. Observe the scene with the right eye closed, especially the right-occluded area. Then observe the same scene with the left eye closed, especially the left occluded area. Then open both eyes and see whether you can still see the right and the left-occluded areas. It is surprising but true that indeed both the right and the left occluded areas are seen in the final fused image.

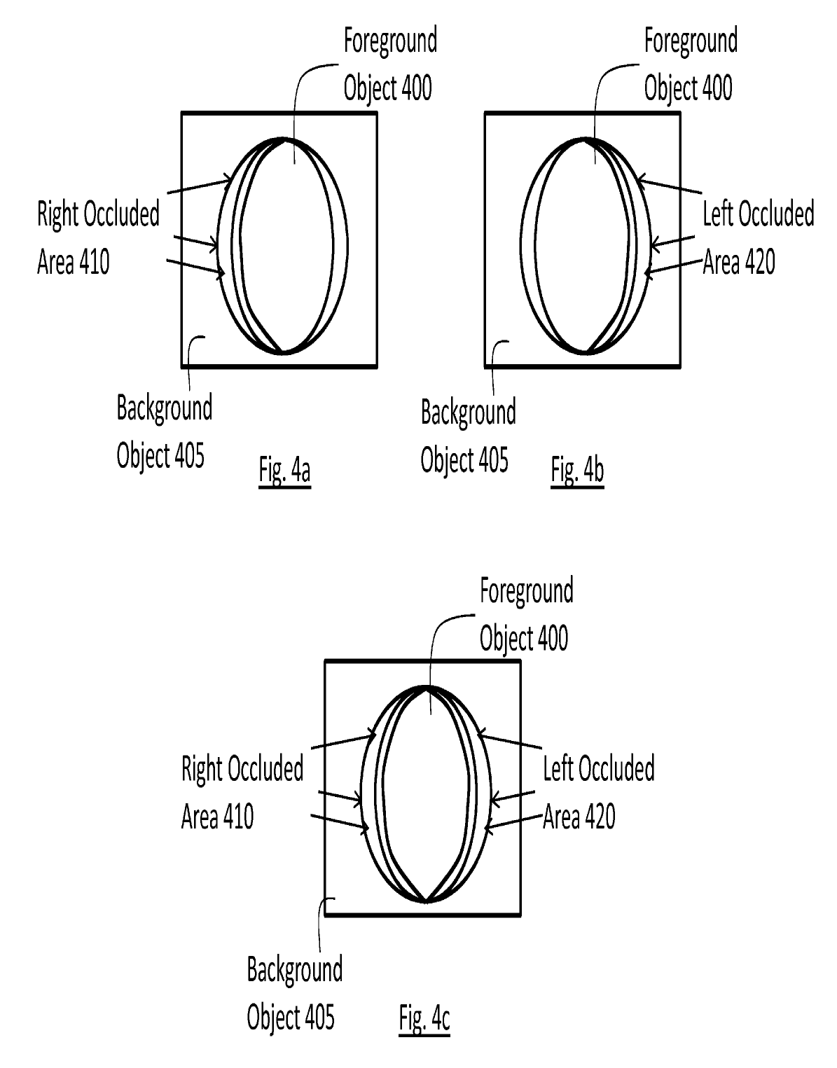

This is shown in more detail in FIG. 4a-4c. FIG. 4a shows left view of a foreground object 400 on a background 405. The object is shown as a ball with stripes at its edges. For the left view, two stripes are seen on the left side, and the portion that is not seen from the right side is the additional stripe on the left side. This is shown as the right-occluded area 410 in FIG. 4a. Similarly, FIG. 4b shows the portion that is not seen from the left side—the additional stripe on the right side—as the left occluded area 420. After opening both eyes, the brain sees the binocular fusion of the right and left occluded areas 410 and 420 as shown in FIG. 4c.

This is an important observation and is the reason why a single view is not sufficient to generate a high fidelity 3D representation in a 2D form. It appears that the SUBSTITUTE SHEET (RULE 26) brain does not want to eliminate any information that is obtained from the left or right eyes and fuses the left and right images without losing any information.

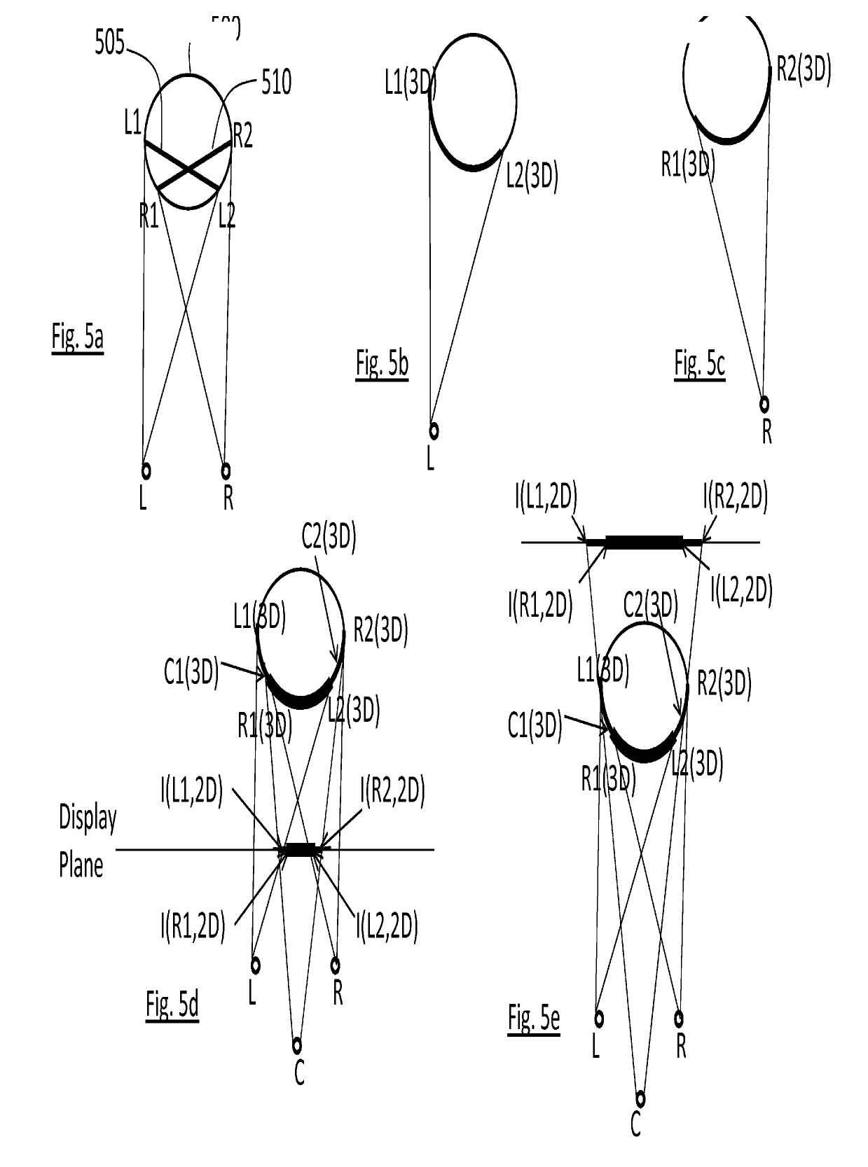

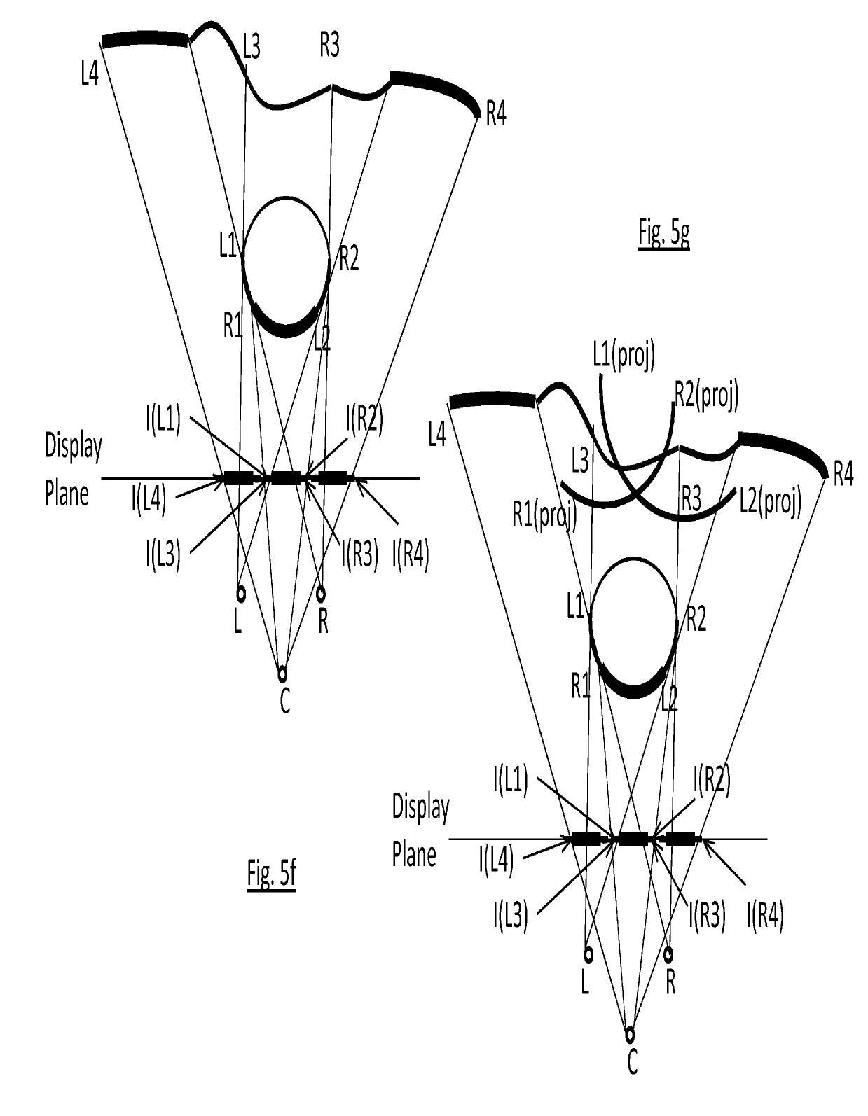

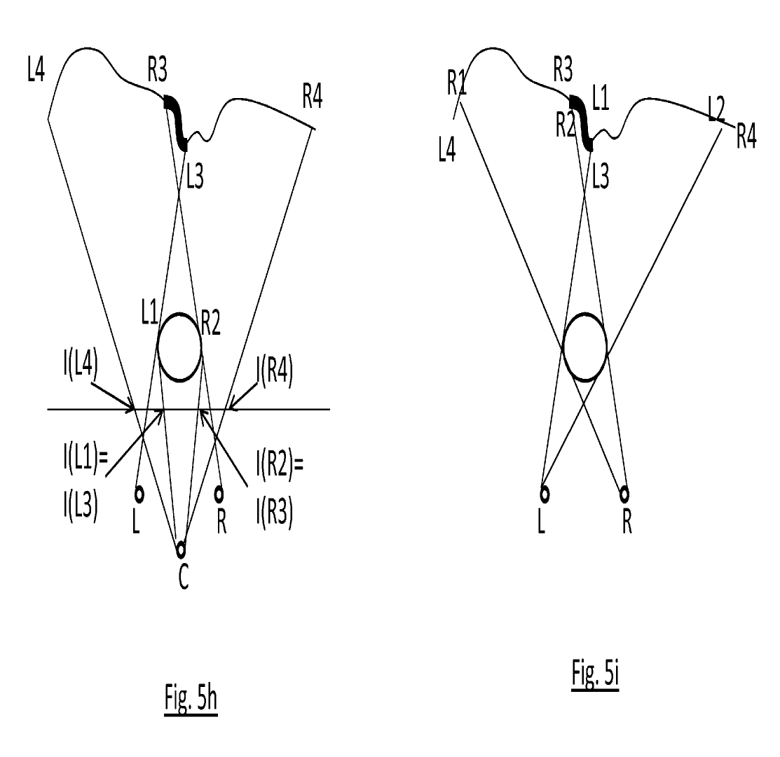

The following describes how the left and the right views can be combined. FIG. 5a shows an object 500 from left and right views from, e.g., two different cameras or from a graphically generated output. Assume that an accurate depth map of the scene is also available. This depth map maybe generated by an active range camera as described in FIG. 1 or maybe generated by video processing of L and R views, for example, as described in http://www.mathworks.com/products/viprocessing/demos.html?file=/products/demos/vipblks/videostereo.html. L1 and L2 denote the extreme edges of the object as seen from the left view. R1 and R2 denote the extreme edges of the object as seen from the right view. The actual view seen in the left view is the 2D projection of the L1-L2 line segment onto the left viewpoint and shown as 505 in FIG. 5a. Similarly the actual view seen on the right view is the 2D projection of the R1-R2 line segment onto the right viewpoint and shown as 510 in FIG. 5a.

The first step is to convert the 2D view to the actual 3D view of the object. Given the depth map, this is a perspective projection onto the 3D view and can be computed according to well known matrix projection techniques as described in “Computer Graphics: Principles and Practice, J. Foley, A. van Dam, S. Feiner, J. Hughes, Addison-Wesley, 2^{nd} Edition, 1997. All projections unless otherwise explicitly stated are assumed to be perspective projections. The projection of L1-L2 line segment onto the 3D view is shown in FIG. 5b as the curved line segment L1(3D)-L2(3D). Similarly the projection of R1-R2 line segment onto the 3D view is shown in FIG. 5c as the curved line segment R1(3D)-R2(3D).

Now both of these segments refer to the same object in 3D space. Given the observation described in FIG. 4c, the fusion of these segments can now be obtained as shown in FIG. 5d as line segment L1(3D)-R1(3D)-L2(3D)-R2(3D). Note that the intensity of R1(3D)-L2(3D) may be combined in a weighted manner, i.e., could be of same/higher/lower intensity than the occluded segments L1(3D)-R1(3D) and L2(3D)-R2(3D).

The final step is to convert this line segment L1(3D)-R1(3D)-L2(3D)-R2(3D) to the display plane for creating a 2D video according to a point where the final user will see the image, and is called the center viewpoint. FIG. 5d shows the case of a background object. Perspective projection of the line segment on the center viewpoint is implemented using standard matrix projection techniques. Note that the projection points on the display plane are computed based on the center viewpoint, but the segment that is projected is the entire segment L1(3D)-R1(3D)-L2(3D)-R2(3D), which is larger than what would have been projected by the object on the display plane, shown as C1(3D)-C2(3D) in the figure, without occlusion handling. Some scaling/warping may be necessary to fit the view within the same image area. As can be seen, the background object gets smaller when projected onto the display plane and creates the proper impression of depth on the brain. Also proper handling of left and right occluded areas makes the image more realistic to the brain.

FIG. 5e shows the case of the foreground object. As can be seen the foreground object is enhanced as would be expected with the proper perspective projection and with proper handling of left and right occluded areas.

In actual implementation, the occluded areas may be enhanced or reduced and/or the line segment projected may be further compressed or enhanced to enhance the look and/or feel. Some scaling/warping may be necessary to fit the view within the same image area, while including both the left and right occluded areas in the combined view.

FIGS. 5f and 5g generalizes the occlusion handling to look at an object with a background. There are two cases to be considered.

In the first case, the point of focus is the foreground as shown in FIG. 5f—in this case the foreground object is treated the same way as described in FIG. 5e. The occlusion region of the background is treated similarly, with the main principle that no information from the eyes is lost. In this case, line segments L4-L3 and R3-R4 map to the display plane as I(L4)-I(L3) and I(R3)-I(R4), respectively according to the projection point C, as shown in FIG. 5f.

In the second case, the point of focus is the background—in this case, the foreground object in the left view L1-L2 is projected onto the background as shown in FIG. 5g as L1(proj)-L2(proj); and the foreground object in the right view R1-R2 is projected onto the background shown as R1(proj)-R2(proj). Then the foreground is blurred and combined with the background. The blurring of the foreground object is done according to the distance from the background object. Note that now a blurry “double” object is seen, which may be used by the brain to correctly estimate the depth of the object. This case is called the case of an object with non-overlapping background, since there is no overlap between L4-L3 and R3-R4 line segments.

FIG. 5h and FIG. 5i consider an object with an overlapping background, the overlapped background is shown as section R3-L3. Again there are two cases to be considered.

In the first case, the point of focus is the foreground as shown in FIG. 5h—in this case the foreground object is treated the same way as described in FIGS. 5e and 5g. The occlusion region of the background is treated similarly, with the twist that the overlap region is repeated twice; the regions L4-L3 and R3-R4 map to the display plane as I(L4)-I(L3) and I(R3)-I(R4), respectively according to the projection point C, and the region R3-R4 is repeated on both sides of the occlusion.

In the second case, the point of focus is the background as in FIG. 5i—in this case, the entire background is combined according to the background views L4-L3 and R3-R4 in 3D space. The foreground object is seen as a “double” view, i.e., the left view is projected as a projection onto the background and then a weighted combination of this projection and the background is seen. This is shown as line segment L1-L2 being combined with the background such that L1 maps to the point L3 as shown. Similarly the right view is also projected as a combination to the background and line segment R1-R2 is mapped to the background such that the R2 point is the same as the R3 point as shown in FIG. 5i. Generally the foreground object is out of focus and very blurry and is represented as a double image. This fused object in 3D space is then projected into the 2D space according to a projection point, similar to what has been described earlier.

Note that it is not necessary to implement all the processing of the foreground and background for the different points of focus. Reduced processing could be done to simplify the implementation based on studies that some of the processing may be sufficient for the brain to create the 3D effect. Or some projections may be modified to use parallel projection instead of perspective projection to give a different look and feel. For instance if the background is in focus, the foreground treatment could be a parallel projection instead of the perspective projection. Clearly there is a balance point between simulating faithfully the video processing in the brain and complexity of implementation, which may be different for a person, groups of people or for all people.

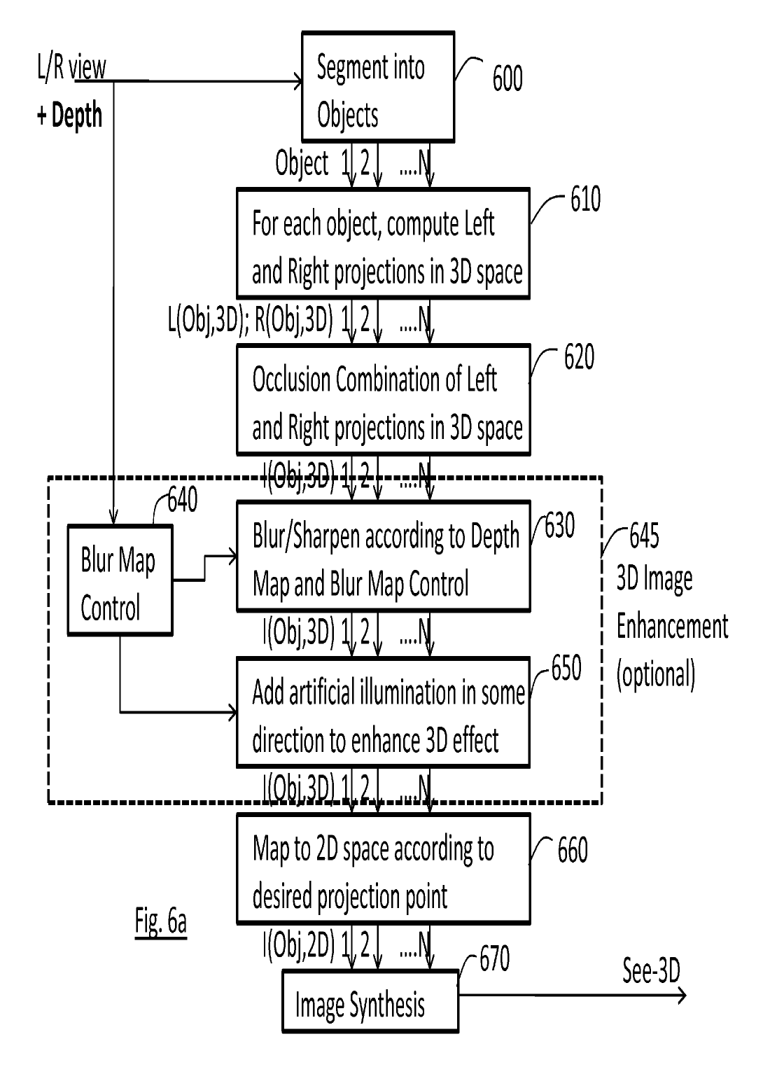

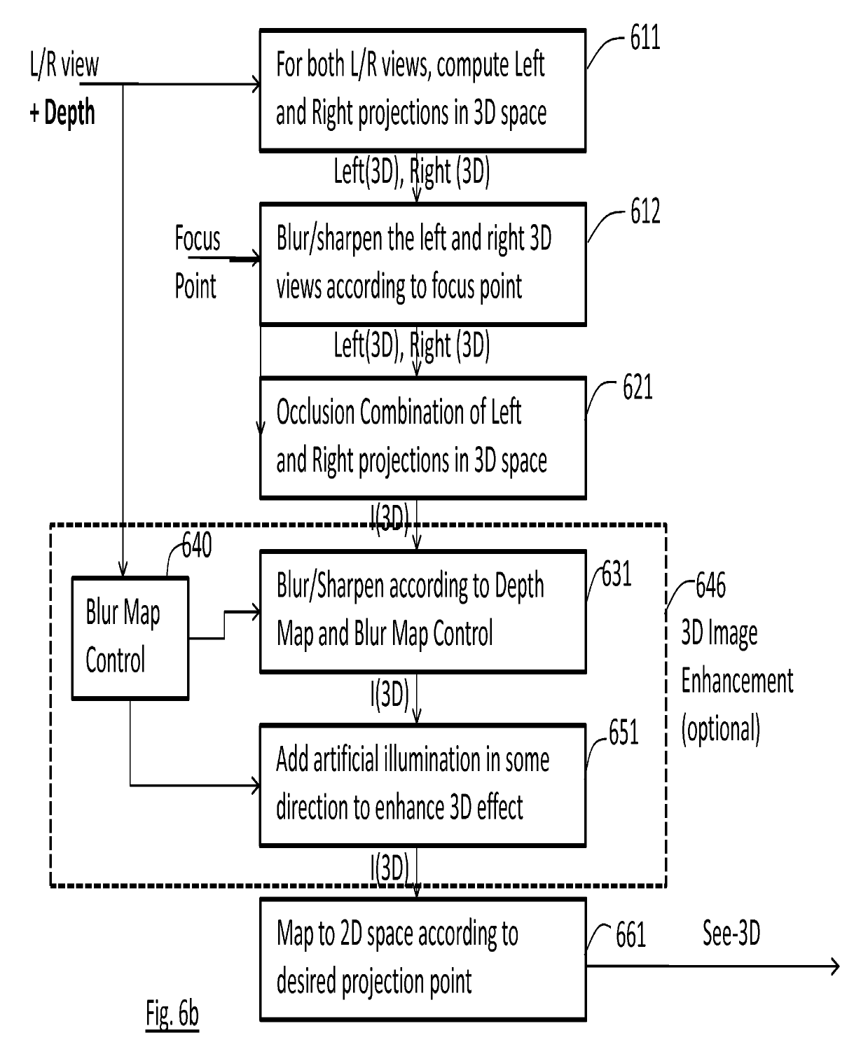

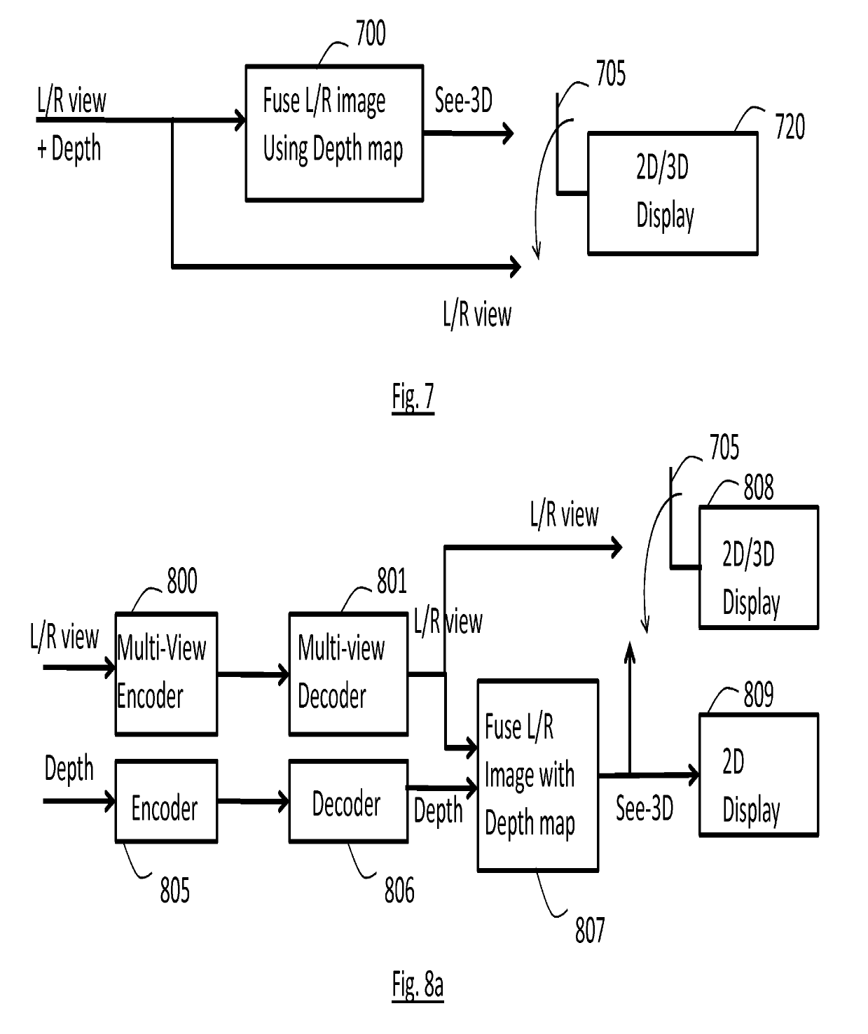

FIG. 6a illustrates one embodiment. Left view, right view and the depth map, for example from block 170 of FIG. 2c or block 240 of FIG. 2b, are sent to an object segmentation block 600, which separates the image into many distinct objects. This maybe done via automated image segmentation approaches, for example, using motion estimation and other such approaches, or via operator assisted segmentation approaches, or while doing the view generation, for example, in a graphics world, where there is an object model for every object and the final image is rendered in layers. For each object, block 610 projects the 2D left and right views to the 3D object view: L(Object, 3D)=Perspective projection (Left, Object, Depth map); R(Object, 3D)=Perspective projection (Right, Object, Depth map).

The occlusion combination block 620 combines the left and the right 3D views. The occlusion combination uses the principles described in FIG. 5d-5i for the different cases of a single object, object with non-overlapping background, and object with overlapping background. In this case the information about the point-of-focus and depth-of-field of the camera is used to determine whether the foreground or the background object was in focus. Appropriate blurring/sharpening separately for the left and right views in accordance with the point-of-focus and the depth field may be necessary before the occlusion combining, especially for case 5(i) of the object with overlapping background with the focus on the background image. Note that the L/R occlusion combination for different points of focus may be sent in a time-sequential manner via an increased frame-refresh rate or via cycling between different focus points in successive frames. Note the blurring/sharpening may not be necessary for the case where multiple L/R cameras were used with different points-of-focus.

The outputs of block 620 then represent the object segments in 3D view corresponding to the given depth map. At this step, another technique that the brain uses to determine depth as explained in FIG. 2a is employed. Depth perception is typically achieved via periodic focusing of the eyes on nearby and distant objects. Since the brain appears to process scenes as collections of objects, this embodiment may sharpen the focus of an object at a certain depth with associated blurring of other objects in accordance with the depth distance from the sharpened depth view. This corresponds to the brain controlling focusing on that particular depth for a particular object. Note that as described in the occlusion combining block, there may be some blurring/sharpening being done separately on the L/R views according to the object position, depth field etc. This is additional blurring/sharpening on the fused L/R view and is used to further enhance the 3D effect.

For every image a particular blur map is used at block 630. The blur map is controlled by the blur map control block 640 as shown. After the image is drawn, drawing of the next image may move the point of focus to other objects, simulating the effect of the brain focusing on different objects. The sequence of images thus created may be viewed in a time-sequential form. For still objects, this results in being able to show all possible depths in focus. For moving objects, the sharpening and blurring operations may be done on the “interesting” parts of the picture, such as large objects, or objects moving not too slowly but also not very quickly such that they remain in focus while still moving fairly quickly, or first focusing on areas of slow motion, or via operator control. In summary, the blur approach may simulate the brain focusing function via periodically changing the focus point.

The blurring/sharpening is done on the fused L/R view. Note it is independent of the procedure by which L/R views are fused, i.e., it may be used for cases when the fused L/R view has already been generated. Or it may be used to enhance the 3D effect for single-view, for example, by using a single camera.

Note that the blurring/sharpening can also be used to enhance 3D storytelling by creatives, who typically distort reality (“suspension of reality”) to create a compelling experience. This has generally been an issue with current conventional 3D stereoscopic medium.

The output of the blur/sharpening block 630 may be sent to another image enhancement block 650. The 3D effect may be enhanced by adding “light” from a source from a specific direction. Clearly this is not what is observed in the real world. Nevertheless this technique may be used to enhance the 3D impression. Given that the depth map of every object is known, the light source may first be projected on the foreground object. Then the shadows of the foreground object and also the reduced light on the background objects may similarly be added.

The 3D illumination enhancement is done on the fused L/R view. Note it is independent of the procedure by which L/R views are fused, i.e., it may be used for cases when the fused L/R view has already been generated. Or it may be used to enhance the 3D effect for single-view, for example, by using a single camera.

Generally both the blur/sharpen function 630 and adding artificial illumination function 650 are optional blocks and maybe viewed as a 3D Image Enhancement block 645 as shown. An advantage is that the 3D Image enhancement block operates in the 3D space and has an associated depth map. Hence all the information to do proper 3D processing is available.

After all the image enhancement functions are done, at block 660 each object may be mapped to the 2D space according to a particular projection point as shown in FIG. 6a, at the center of the left and the right view line. As explained earlier, this projection may be implemented via standard perspective projection matrix operation. The occluded areas may be enhanced or reduced depending on the kind of effect that is desired.

After all the 2D objects have been generated, the full 2D image is obtained by combining all the pixels associated with all the 2D objects together in the image synthesis block 670, as shown in FIG. 6a. One approach may be to first start with the foreground object and then successively continue until all the objects are completed. Wherever there is conflict, the foreground object pixel maybe used before the background object pixel. If there are any “holes”, then the adjacent foreground object can be scaled appropriately, or a pixel maybe repeated from the background object. Thus See-3D video can be generated from the L/R views and the depth map. This video can now be shown on a 2D display and achieve the desired 3D effect.

FIG. 6b shows an alternative embodiment. Dividing a particular image into multiple objects accurately can be quite expensive. It is possible to treat the entire L/R views by making some simplifications as can be seen from FIG. 5d-5i.

For the case of a foreground object, when the camera is focused on the foreground object, then the resulting image is the 2D perspective projection of the 3D combination of all the foreground and background occlusion and non-occluded areas. Essentially the brain wants to see all the information from both the left and right views. This principle is valid for both the cases of objects with overlapping or non-overlapping backgrounds.

In the case of a background object, first the foreground object in both the left and right views may be blurred and then projected onto each specific left or right view. The blurred foreground object may be combined with the background for each of the Left and Right views. Then the two views may be combined to create a common 3D view, which is projected to the display plane.

For a given object in focus, an object in front of it may be treated as a foreground object, and an object behind it may be treated as a background object. Two views may then be easily created, one at the extreme background and the other at the extreme foreground. Views in the middle may be created by first pushing all the foreground objects to the point of focus and then reducing the resulting object as one large foreground object. Many such simplifications are possible.

FIG. 6b shows an embodiment of this idea. For the entire L/R view, first the whole view may be projected to the 3D plane by block 611. Then appropriate blurring/sharpening may be done based on a specified point of focus by block 612. Note this blurring/sharpening may be done separately on both the L/R views. Then the occlusion combination of the entire L/R views using the principles described above is implemented in block 621. As in FIG. 6a, an optional blurring/sharpening block 631 now operating on the fused-L/R view and an optional illumination enhancement block 651 under the blur control block 640 may also be implemented. Finally the 3D view is mapped to the 2D space using block 661, which outputs See-3D video.

The process of generating the See-3D video may also be used to ameliorate the limitations of a 2D/3D autostereoscopic or stereoscopic display (called a 2D/3D display). FIG. 7 shows an embodiment that may be used to improve the 2D/3D display. Assuming L/R views and the associated depth map is available, for example from block 170 of FIG. 2c or block 240 of FIG. 2b, block 700 creates the See-3D video in accordance with the embodiment of FIG. 6a. The 2D/3D display 720 periodically samples the outputs of blocks 700 and the L/R views. In this manner, the “fallback” 3D image is seen with full resolution periodically, while the additional L/R views provide some stereopsis cues as well. The switching function 705 may be a function of the amount of negative depth (which translates into a higher requirement for stereopsis cues) and/or a function of the distance of the user from the screen obtained, for example, via eyetracking approaches. With this approach, the advantages include: the capability to support multiple views and improved resolution; the ability to obtain better coverage and graceful degradation from a “true” 3D effect to a “simulated” 3D effect; the “simulated” 3D effect dominating the user experience when in a non-coverage zone; and, better illumination due to lesser loss of illumination in a 2D mode.

There are at least two approaches to generate an accurate depth map as described above: via capture of depth information at the source and via calculation of a depth map from L/R views. While, on the one hand, having to send the depth map results in a higher information bandwidth requirement, on the other hand, it results in significantly improved quality. So approaches that minimize the transmission bandwidth while still achieving better quality are desirable.

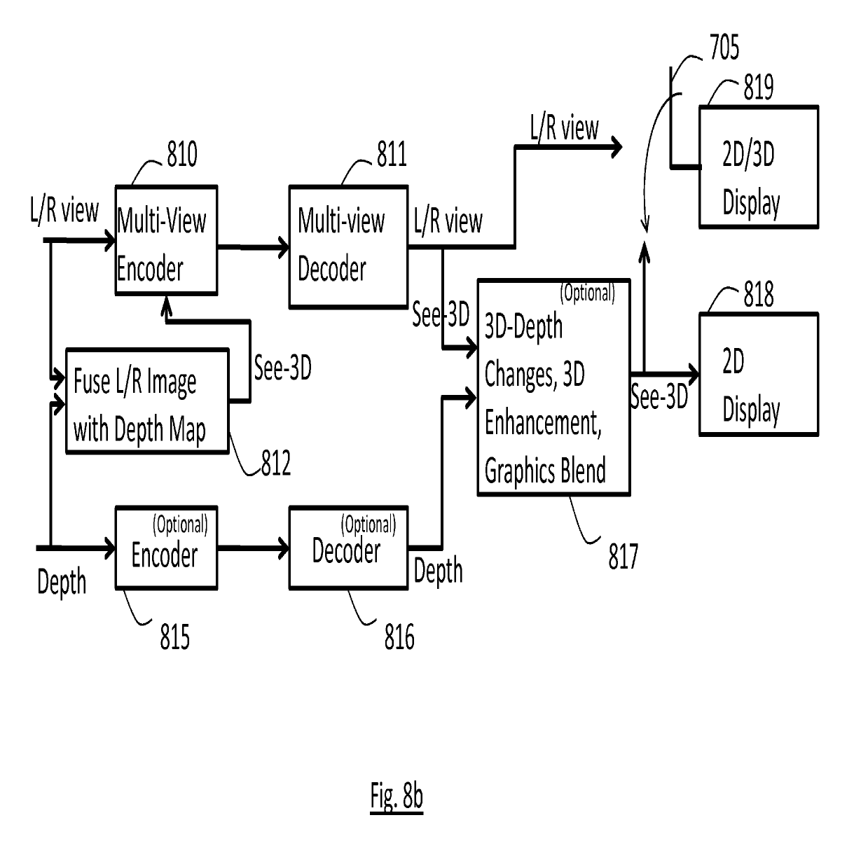

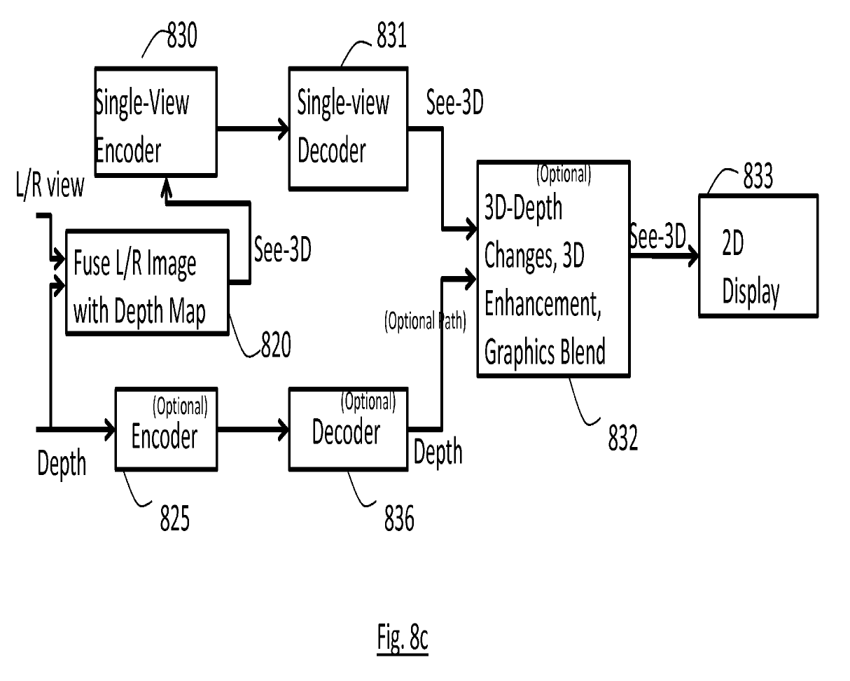

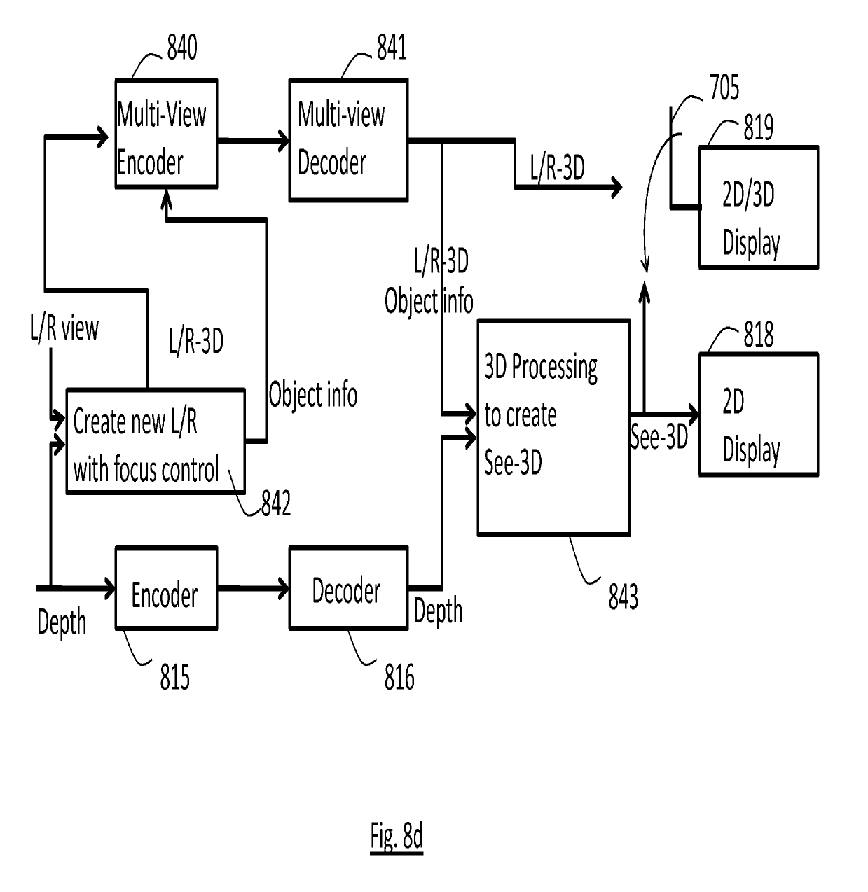

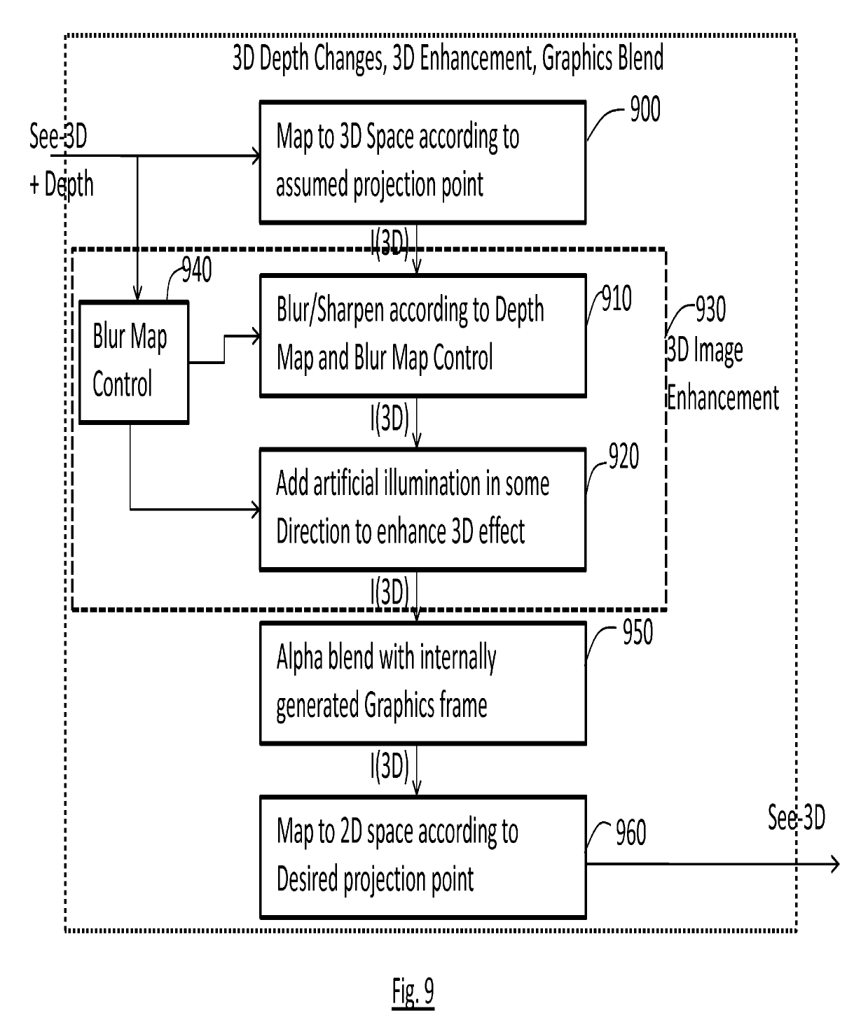

FIG. 8a shows an encoder-decoder-display system according to one embodiment, assuming L/R views and the depth map is obtained from the source. The encoder block 800 encodes L/R views according to multiple 3D encoding formats, for example MVC, RealD, Dolby, etc. A separate H.264 encoder may be used to encode the depth map. Typically there is a lot of redundancy between frames and also within a frame, hence good compression is expected. According to “Depth-Image-Based Rendering (DIBR), Compression and Transmission for a New Approach on 3D-TV”, Christoph Fehn, Report at Heinrich-Hertz-Institut (HHI), depth compression adds less than 10% to the corresponding MPEG-2 encoded data rate. The depth map includes depth information from both visible and occluded areas. At the receiver, the decoders 801 and 806 perform the inverse function of the encoders 800 and 805. Block 807 creates the See-3D video according to this embodiment. An advantage of this technique is that the same format can be used to support a 2D/3D display, shown in FIG. 8a as block 808, or a conventional display 809 using the See-3D video. A disadvantage is that the process of computing a See-3D video is computationally quite expensive.

In another embodiment, the encoder in FIG. 8b enables reducing receiver complexity by adding another view, using the MV (multi-view) encoder 810, which uses the output of block 812. Although the depth map is typically not required in this embodiment, since the See-3D video is already available, it may be useful to do further depth-based adjustments based on eyetracking information and/or 3D image enhancements at the receiver. Hence an optional encoder block 815 is also shown for the depth map. At the receiver, blocks 811 and 816 form the inverse of the transmitter. Block 817 adds 3D depth changes, or 3D enhancement effects or blends locally created graphics. The depth map allows for the See-3D video to be mapped back to the 3D space and 3D image enhancements can easily be made in the 3D space. Local 3D graphics objects can also be blended by this approach using the 3D view. Finally depth adjustments, for example, based on eye-tracking information, can easily be implemented by mapping the 3D view to the new depth point. The L/R and the See-3D video views can then be sent to block 819 for a 2D/3D display. Alternatively, only the See-3D video can be sent to the 2D Display block 818.

While the embodiment of FIG. 8b reduces receiver complexity, it increases required transmission bandwidth. In another embodiment, a significant simplification can result by sending only the See-3D video, as shown in FIG. 8c as block 820, using encoder 830. The depth map may optionally be encoded by block 825 and sent as well. The decoder blocks 831 and 826 perform the inverse functions of the corresponding encoders. Block 832 is as described with respect to block 817 in FIG. 8b. The main limitation of this embodiment is that only a conventional 2D display 833 can be supported.

FIG. 9 describes the block 832 in FIG. 8c or block 817 in FIG. 8b in more detail. Given the See-3D video and the depth map, block 900 maps the 2D video on the 3D space. Block 910 can do blurring/sharpening according to the blur map control block 940. Block 920 can do the illumination enhancement as explained before. Block 950 creates locally created graphics objects in 3D space and blends it in the 3D space. Block 960 maps it to the 2D space to create a 3D-enhanced & graphics blended See-3D video.

The preceding describes a technique of creating See-3D video out of L/R images and a depth map. It also describes multiple ways of encoding, transmission and decoding of this information. Specifically it describes three different techniques of transmission: (i) the L/R view(s) and the depth map. The additional depth information can be encoded separately; (ii) L/R view(s) and the See-3D video as an additional view computed as described above. The depth map can also be sent to enable optional 3D depth changes, 3D enhancement, and add locally generated 3D graphics; (iii) See-3D video and an optional depth map for 3D depth changes, 3D enhancement, and add locally generated graphics.

Standard compression techniques including MVC, H.264, MPEG, WMV, etc. can be used after the specific frames are created in accordance with any of the above (i)-(iii) approaches.

An advantage of using only the L/R view(s) and depth map as described above in (i) is that it can be made “backward-compatible”. The additional depth information can easily be sent as side information. A drawback is that the burden of generating See-3D video must be carried by the receiver.

An advantage of using L/R views and the See-3D views and the optional depth map as described in (ii) is that the complexity of processing is at the encoder. A drawback is that it is wasteful in terms of transmission bandwidth, and it is not backward-compatible.

Advantages of using only the See-3D view and the optional depth map as described in (iii) is that the transmission bandwidth is minimized and also that the complexity of the receiver is minimized. However, this technique does not support stereoscopic displays or autostereoscopic displays requiring separate L/R view information.

The following describes further means of encoding, transmission and reception including: creating an enhanced L/R-3D view using the L/R information and the depth map control; encoding the L/R-3D views and depth map information as described in (i); and, determining object based information at the transmitter and sending that as side information. At the receiver: decoding the L/R-3D views and depth map information; showing the L/R-3D view on a stereoscopic or an autostereoscopic display; creating the See-3D video to display on a conventional 2D display using the enhanced L/R-3D views, depth map information and the object-based information.

An advantage is that the stereoscopic or an autostereoscopic display also takes advantage of 3D focus-based enhancement as described in FIG. 5a-5i. The following describes splitting the processing shown in FIG. 6b into two portions: processing which retains the Left and the Right views is done at the transmitter; and, processing which combines the Left and Right views to create See-3D is done at the receiver. Note that a stereoscopic or an autostereoscopic display takes advantage of the 3D focus-based enhancement.

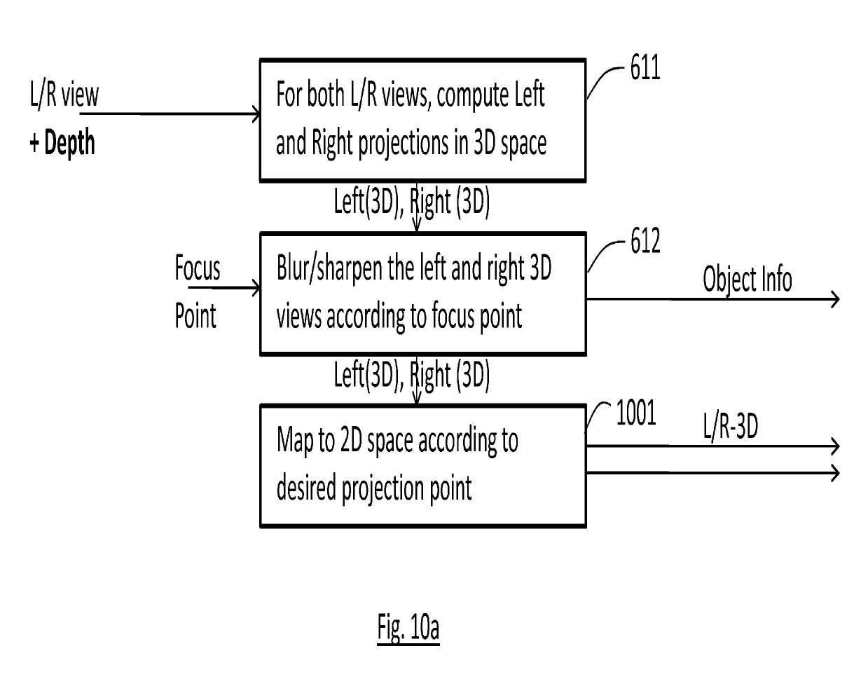

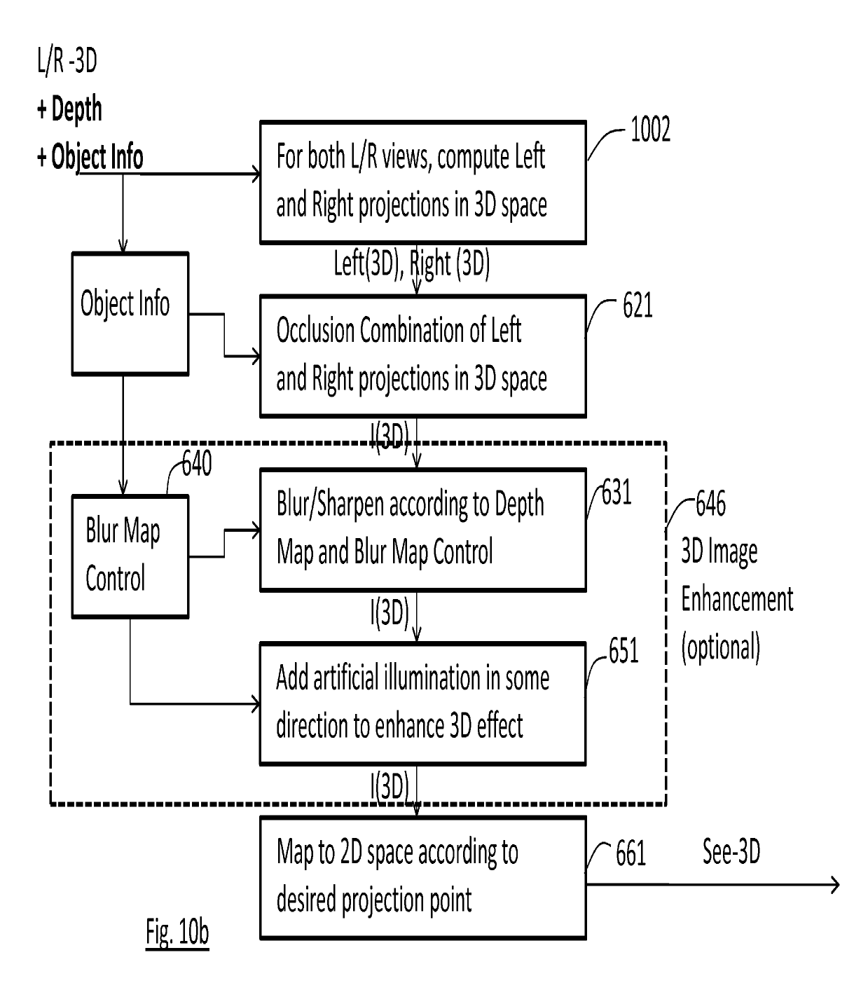

Referring now to FIG. 8d, instead of sending the L/R views directly to the multi-view encoder as in FIG. 8a or 8b, block 842 sends processed L/R views, referred to herein as L/R-3D views, to the multi-view encoder block 840. The processing of encoder block 842 is further described in FIG. 10a. The Left and Right views are projected into 3D space by block 611 using the depth map information as described in FIG. 6b. The focus point information is then used to blur/sharpen the 3D views in accordance with the description of FIG. 5a-5i and as described by block 621 in FIG. 6b. Any object-based information used is sent as well. The object-based information could be a bitmap describing different objects or could use graphical object representations. The focus-enhanced L/R views are then projected onto the 2D space and sent as L/R 3D information as represented by block 1001. Note that separate left and right views are created. Also the information about objects is sent as side information to be encoded separately by block 840, as shown. A depth encoder 815 is also used at the transmitter.

At the receiver, block 841 performs the inverse of block 840. The enhanced L/R-3D views can be sent directly to a stereoscopic or an autostereoscopic display. The L/R-3D views, the object information and the depth map obtained as the output of the depth decoder 816 can then be used to create the See-3D video as shown in block 843. More detail on block 843 is shown in FIG. 10b. The L/R focus enhanced views are projected onto the 3D space using the depth map by block 1002, which is essentially an inverse of block 1001. Occlusion combining as described in block 621 in FIG. 6b is then implemented using object based information sent as side information. The remainder of the blocks —631, 641, 651, 661—are as described with reference to FIG. 6b.

Note that while the embodiment in FIG. 6b is used to illustrate how the overall processing of See-3D is split within the transmitter and the receiver, a similar approach can also be used with alternative embodiments such as in FIG. 6a. The processing is split such that: while the views are still Left and Right, the processing is done in the transmitter. This enables backward compatibility of using these views for a stereoscopic or an autostereoscopic display. Note that the focus-based enhancement is useful to improve the 3D effect using a stereoscopic display—this will improve the cues that are presented to the brain and thereby reduce the health impact of prolonged 3D viewing of a stereoscopic display. The combining of the Left and Right views is done at the receiver to create the See-3D video.

The embodiments of the present invention may be implemented with any combination of hardware and software. For example, in embodiments, any of the steps of FIGS. 6a, 6b, 9, 10a and 10b, and/or any of the blocks of FIG. 8a-8d may be implemented in one or more integrated circuits and/or one or more programmable processors. As only one of many possible examples, an embodiment of FIG. 6b may comprise an input interface unit for receiving L/R view information and depth information, a first processing unit for computing left and right projections of the L/R view information in three-dimensional space, a second processing unit for combining the occluded portions of the computed projections in three-dimensional space, a third processing unit for mapping the combined projections to two-dimensional space according to a desired projection point; and an output interface unit for providing See-3D image information from the mapped object projections, wherein each of these functional units may be partitioned across one or more integrated circuits, and/or one or more programmable processors, in implementations. If implemented as a computer-implemented apparatus, the present invention is implemented using means for performing all of the steps and functions described above.

The embodiments of the present disclosure can be included in an article of manufacture (e.g., one or more computer program products) having, for instance, computer useable or computer readable media. The media has embodied therein, for instance, computer readable program code means, including computer-executable instructions, for providing and facilitating the mechanisms of the embodiments of the present disclosure. The article of manufacture can be included as part of a computer system or sold separately.

The embodiments of the present disclosure relate to all forms of visual information that can be processed by the human brain, and includes still images, video, and/or graphics. For example, still image applications include aspects such as photography applications; print media such as magazines; e-readers; websites using still images.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present invention is not limited to the particular examples and implementations disclosed herein, but is intended to cover modifications within the spirit and scope thereof as defined by the appended claims and any and all equivalents thereof.

1. A method of generating See-3D information, comprising:
(a) computing left and right projections of L/R view information in three-dimensional space;
(b) combining occluded portions of the computed projections in three-dimensional space; and
(c) mapping the combined projections to two-dimensional space according to a desired projection point.

2. The method of claim 1, further comprising:
between steps (b) and (c), processing, selected from the group comprising blurring and sharpening, the combined occluded portions of the projections; and
adding artificial illumination to the processed combined occluded portions of the projections.

3. The method of claim 1, further comprising:
prior to step (a), segmenting the L/R view information into objects;
performing steps (b) and (c) on an object basis; and
after step (c), synthesizing images from the mapped object projections.

4. The method of claim 1, further comprising, between steps (a) and (b), processing, selected from the group comprising blurring and sharpening, according to a specified focus point, the left and right projections.

5. The method of claim 1, wherein step (b) is performed according to a specified focus point.

6. The method of claim 1, wherein step (b) is performed based on object information.

7. A method of displaying See-3D information, comprising:
when a display is a 2D display, displaying See-3D information selected from the group comprising received See-3D information, See-3D information generated from received L/R view information and received depth information, See-3D information 3D-enhanced and graphics blended from received See-3D information and received depth information, and See-3D information generated from received L/R-3D object information and received depth information; and
when a display is a 2D/3D display, alternately displaying See-3D information and received L/R view information, wherein the See-3D information is selected from the group comprising received See-3D information, See-3D information generated from the received L/R view information and received depth information, See-3D information 3D-enhanced and graphics blended from received See-3D information and received depth information, and See-3D information generated from received L/R-3D object information and received depth information.

8. The method of claim 7, wherein the display displays the See-3D information generated from the received L/R view information and the received depth information.

9. The method of claim 7, wherein the display displays the See-3D information 3D-enhanced and graphics blended from the received See-3D information and the received depth information.

10. The method of claim 7, wherein the display displays the received See-3D information.

11. The method of claim 7, wherein the display displays the See-3D information generated from the received L/R-3D object information and the received depth information

12. An apparatus for generating See-3D images, comprising:
an input interface unit for receiving L/R view information and depth information;
a first processing unit for computing left and right projections of the L/R view information in three-dimensional space;
a second processing unit for combining occluded portions of the computed projections in three-dimensional space;
a third processing unit for mapping the combined projections to two-dimensional space according to a desired projection point; and
an output interface unit for providing See-3D image information from the mapped object projections.
